(19) United States
(12) Patent Application Publication
(10) Pub. No.: US 2023/0383034 A1
(43) Pub. Date: Nov. 30, 2023

(54) COPOLYMER, MOLDED BODY, INJECTION MOLDED BODY, AND COATED ELECTRICAL WIRE

(71) Applicant: DAIKIN INDUSTRIES, LTD., Osaka (JP)

(72) Inventors: Tadaharu ISAKA, Oaaka (JP); Yumi Zenke, Osaka (JP); Yukari Yamamoto, Osaka (JP); Hayato Tsuda, Osaka (JP); Hiroyuki Hamada, Osaka (JP)

(73) Assignee: DAIKIN INDUSTRIES, LTD., Osaka (JP)

(21) Appl. No.: 18/446,746

(22) Filed: Aug. 9, 2023

Related U.S. Application Data
(63) Continuation of application No. PCT/JP2022/003645, filed on Jan. 31, 2022.

(30) Foreign Application Priority Data
Feb. 26, 2021 (JP) 2021-031096
Sep. 30, 2021 (JP) 2021-162078

(51) Int. Cl. C08F 214/26; H01B 3/44

(52) U.S. Cl. CPC C08F 214/265; H01B 3/445

(57) ABSTRACT

There is provided a copolymer containing tetrafluoroethylene unit and perfluoro(propyl vinyl ether) unit, wherein the copolymer has a content of perfluoro(propyl vinyl ether) unit of 3.3 to 4.2% by mass with respect to the whole of the monomer units, the melt flow rate at 372° C. of 27.0 to 35.0 g/10 min, and the number of functional groups of 20 or less per 10⁶ main-chain carbon atoms.

### CROSS-REFERENCE TO RELATED APPLICATIONS

This application is a Rule 53(b) Continuation of International Application No. PCT/JP2022/003645 filed Jan. 31, 2022, which claims priorities based on Japanese Patent Application No. 2021-031096 filed Feb. 26, 2021 and Japanese Patent Application No. 2021-162078 filed Sep. 30, 2021, the respective disclosures of which are incorporated herein by reference in their entirety.

### TECHNICAL FIELD

The present disclosure relates to a copolymer, a formed article, an injection molded article, and a coated electric wire.

### BACKGROUND ART

Patent Document 1 describes a coated electric wire comprising a core wire coated with a tetrafluoroethylene [TFE]-based copolymer, wherein the TFE-based copolymer has TFE unit derived from TFE and perfluoro(alkyl vinyl ether) [PAVE] unit derived from PAVE, contains more than 5% by mass and 20% by mass or less PAVE unit with respect to the whole of the monomer units, contains fewer than 10 unstable terminal groups per 1×10⁶ carbon atoms, and has a melting point of 260° C. or higher.

### RELATED ART

### Patent Documents

Patent Document 1: Japanese Patent Laid-Open No. 2009-059690

### SUMMARY

According to the present disclosure, there is provided a copolymer containing tetrafluoroethylene unit and perfluoro(propyl vinyl ether) unit, wherein the copolymer has a content of perfluoro(propyl vinyl ether) unit of 3.3 to 4.2% by mass with respect to the whole of the monomer units, a melt flow rate at 372° C. of 27.0 to 35.0 g/10 min, and the number of functional groups of 20 or less per 10⁶ main-chain carbon atoms.

### Effects

According to the present disclosure, there can be provided a copolymer that is capable of providing an injection molded article having excellent surface smoothness by injection molding in a high productivity, and that is capable of providing a formed article which has extremely good water vapor low permeability, which has excellent 150° C. abrasion resistance, nitrogen low permeability, chemical solution low permeability, high-temperature tensile creep property, deterioration resistance against repetitive load, high-temperature rigidity, and ozone resistance, which hardly deforms at high temperatures, which hardly cracks even when brought into contact with a chemical, and which hardly makes fluorine ions to dissolve out in a chemical solution such as a hydrogen peroxide solution.

### DESCRIPTION OF EMBODIMENTS

Hereinafter, specific embodiments of the present disclosure will be described in detail, but the present disclosure is not limited to the following embodiments.

A copolymer of the present disclosure contains tetrafluoroethylene (TFE) unit and a perfluoro(propyl vinyl ether) (PPVE) unit.

A copolymer (PFA) containing TFE unit and a PPVE unit has excellent chemical resistance, and is thus used as a material for forming a wafer carrier that is used in transporting, storing, washing, and drying wafers. Recently, wafers having a larger diameter are in use, and thus demand exists for a large wafer carrier to improve the efficiency of manufacturing semiconductors. Since a wafer carrier and wafers come into direct contact, a wafer carrier is required to have a high level of cleanliness so as not to contaminate wafers. Moreover, the wafer carrier is required to have a high level of durability so as not to be damaged even when repeatedly washed with water or a chemical and thermally dried. When a spin dryer is used to dry wafers that are accommodated in a wafer carrier, durability against centrifugal force is also required.

Patent Document 1 describes that in the tetrafluoroethylene [TFE]-based copolymer having TFE unit derived from TFE and perfluoro(alkyl vinyl ether) [PAVE] unit derived from PAVE, the PAVE unit exceeding 5% by mass with respect to the whole of the monomer units as enhancing melt fabricability and improving crack resistance. However, there is no known copolymer that is capable of providing a formed article having a high level of cleanliness and a high level of durability.

It has been found that by suitably regulating the content of the PPVE unit, the melt flow rate (MFR), and the number of functional groups of a copolymer containing a TFE unit and a PPVE unit, the moldability of the copolymer is significantly improved and, at the same time, the copolymer can be obtained that is capable of providing a formed article which has extremely good water vapor low permeability, has excellent 150° C. abrasion resistance, nitrogen low permeability, chemical solution low permeability, high-temperature tensile creep property, deterioration resistance against repetitive load, high-temperature rigidity, and ozone resistance, which hardly deforms at high temperatures, which hardly cracks even when brought into contact with a chemical, and which hardly makes fluorine ions to dissolve out in a chemical solution such as a hydrogen peroxide solution. Accordingly, by using the copolymer of the present disclosure, a large wafer carrier having excellent surface smoothness can be produced in a high productivity. Moreover, the wafer carrier obtained using the copolymer of the present disclosure hardly contaminate wafers, is hardly damaged even when repeatedly washed with water, ozone water or a chemical and thermally dried, and is hardly damaged even when a large centrifugal force is applied.

In addition, with the copolymer of the present disclosure, a thin, defect-free coating layer can be formed by extrusion forming at a high rate on a core wire having a small diameter without coating discontinuity. Thus, the copolymer of the present disclosure can be utilized not only as a material for a wafer carrier, but also in a broad range of applications such as an electric wire coating.

The copolymer of the present disclosure is a melt-fabricable fluororesin. Being melt-fabricable means that a polymer can be melted and processed by using a conventional processing device such as an extruder or an injection molding machine.

The content of the PPVE unit of the copolymer is 3.3 to 4.2% by mass with respect to the whole of the monomer units. The content of the PPVE unit of the copolymer is preferably 3.4% by mass or higher, more preferably 3.5% by mass or higher, still more preferably 3.6% by mass or higher and especially preferably 3.7% by mass or higher, and is preferably 4.1% by mass or lower, more preferably 4.0% by mass or lower, and still more preferably 3.9% by mass or lower. When the content of the PPVE unit of the copolymer is excessively large, the formed article likely deforms at high temperatures and has poor water vapor low permeability, nitrogen low permeability, chemical solution low permeability, high-temperature tensile creep property, and high-temperature rigidity. An excessively small content of the PPVE unit of the copolymer likely results in cracks when the formed article is brought into contact with a chemical, and results in poor 150° C. abrasion resistance, deterioration resistance against repetitive load, and ozone resistance.

The content of the TFE unit of the copolymer is, with respect to the whole of the monomer units, preferably 95.8 to 96.7% by mass, more preferably 95.9% by mass or higher and still more preferably 96.0% by mass or higher, and is preferably 96.6% by mass or lower, more preferably 96.5% by mass or lower, especially preferably 96.4% by mass or lower and most preferably 96.3% by mass or lower. When the content of the TFE unit of the copolymer is excessively small, the formed article likely deforms at high temperatures, and possibly has poor water vapor low permeability, nitrogen low permeability, chemical solution low permeability, high-temperature tensile creep property, and high-temperature rigidity. An excessively small content of the TFE unit of the copolymer likely results in cracks when the formed article is brought into contact with a chemical, and possibly results in poor 150° C. abrasion resistance, deterioration resistance against repetitive load, and ozone resistance.

In the present disclosure, the content of each monomer unit in the copolymer is measured by a ¹⁹F-NMR method.

The copolymer can also contain a monomer unit derived from a monomer copolymerizable with TFE and PPVE. In this case, the content of the monomer unit copolymerizable with TFE and PPVE is, with respect to the whole of the monomer units of the copolymer, preferably 0 to 0.9% by mass, more preferably 0.05 to 0.6% by mass, and still more preferably 0.1 to 0.5% by mass.

The monomers copolymerizable with TFE and PPVE may include hexafluoropropylene (HFP), vinyl monomers represented by CZ¹Z²═CZ³ (CF₂)ₙZ⁴ wherein Z¹, Z² and Z³ are identical or different, and represent H or F; Z⁴ represents H, F or Cl; and n represents an integer of 2 to 10, perfluoro(alkyl vinyl ether) [PAVE] represented by CF₂═CF—ORf¹ wherein Rf¹ is a perfluoroalkyl group having 1 to 8 carbon atoms (excluding PPVE), and alkyl perfluorovinyl ether derivatives represented by CF₂═CF—OCH₂—Rf¹ wherein Rf¹ represents a perfluoroalkyl group having 1 to 5 carbon atoms. Among these, HFP is preferred.

The copolymer is preferably at least one selected from the group consisting of a copolymer consisting only of the TFE unit and the PPVE unit, and TFE/HFP/PPVE copolymer, and is more preferably a copolymer consisting only of the TFE unit and the PPVE unit.

The melt flow rate (MFR) of the copolymer is 27.0 to 35.0 g/10 min. The MFR of the copolymer is preferably 27.1 g/10 min or higher, more preferably 28.0 g/10 min or higher and still more preferably 29.0 g/10 min or higher, and is preferably 34.0 g/10 min or lower, more preferably 33.9 g/10 min or lower, still more preferably 33.3 g/10 min or lower, further preferably 33.0 g/10 min or lower, further more preferably, still further more preferably 32.9 g/10 min or lower, especially preferably 32.0 g/10 min or lower, particularly preferably 31.0 g/10 min or lower and most preferably 30.0 g/10 min or lower. Due to that the MFR of the copolymer is in the above range, the moldability of the copolymer is improved, and also a formed article can be obtained that has extremely good water vapor low permeability, that has excellent 150° C. abrasion resistance, nitrogen low permeability, chemical solution low permeability, high-temperature tensile creep property, deterioration resistance against repetitive load, high-temperature rigidity, and ozone resistance, that hardly deforms at high temperatures, that hardly cracks even when brought into contact with a chemical, and that hardly makes fluorine ions to dissolve out in a chemical solution such as a hydrogen peroxide solution. With the MFR being excessively low, it may be difficult to obtain an injection molded article having excellent surface smoothness when the copolymer is injection-molded, and the formed article obtained from the copolymer may have poor water vapor low permeability, nitrogen low permeability, and high-temperature rigidity. With the MFR being excessively high, the 150° C. abrasion resistance and the ozone resistance of the formed article obtained from the copolymer may be poor, and cracks may be likely created when the formed article is brought into contact with a chemical.

In the present disclosure, the MFR is a value obtained as a mass (g/10 min) of the polymer flowing out from a nozzle having an inner diameter of 2.1 mm and a length of 8 mm per 10 min at 372° C. under a load of 5 kg using a melt indexer, according to ASTM D1238.

The MFR can be regulated by regulating the kind and amount of a polymerization initiator to be used in polymerization of monomers, the kind and amount of a chain transfer agent, and the like.

In the present disclosure, the number of functional groups per 10⁶ main-chain carbon atoms of the copolymer is 20 or less. The number of functional groups per 10⁶ main-chain carbon atoms of the copolymer is preferably 15 or less, more preferably 10 or less, and still more preferably less than 6. Due to that the number of functional groups of the copolymer is in the above range, a formed article can be obtained that has excellent ozone resistance and that hardly makes fluorine ions to dissolve out in a chemical solution such as a hydrogen peroxide solution.

For the identification of the kind of the functional groups and measurement of the number of the functional groups, infrared spectroscopy can be used.

The number of the functional groups is measured, specifically, by the following method. First, the copolymer is formed by cold press to prepare a film of 0.25 to 0.30 mm in thickness. The film is analyzed by Fourier transform infrared spectroscopy to obtain an infrared absorption spectrum, and a difference spectrum against a base spectrum that is completely fluorinated and has no functional groups is obtained. From an absorption peak of a specific functional group observed on this difference spectrum, the number N of the functional group per 1×10⁶ carbon atoms in the copolymer is calculated according to the following formula (A).

N=I×K/t (A)
I: absorbance
K: correction factor
t: thickness of film (mm)

For reference, for some functional groups, the absorption frequency, the molar absorption coefficient and the correction factor are shown in Table 1. Then, the molar absorption coefficients are those determined from FT-IR measurement data of low molecular model compounds.

TABLE 1

| | | Molar | | |
|---|---|---|---|---|
| | Absorption | Extinction | | |
| Functional | Frequency | Coefficient | Correction | |
| Group | (cm⁻¹) | (l/cm/mol) | Factor | Model Compound |
| —COF | 1883 | 600 | 388 | C₇F₁₅COF |
| —COOH | 1815 | 530 | 439 | H(CF₂)₆COOH |
| free | | | | |
| —COOH | 1779 | 530 | 439 | H(CF₂)₆COOH |
| bonded | | | | |
| —COOCH₃ | 1795 | 680 | 342 | C₇F₁₅COOCH₃ |
| —CONH₂ | 3436 | 506 | 460 | C₇H₁₅CONH₂ |
| —CH₂OH₂, | 3648 | 104 | 2236 | C₇H₁₅CH₂OH |
| —OH | | | | |
| —CF₂H | 3020 | 8.8 | 26485 | H(CF₂CF₂)₃CH₂OH |
| —CF═CF₂ | 1795 | 635 | 366 | CF₂═CF₂ |

Absorption frequencies of —CH₂CF₂H, —CH₂COF, —CH₂COOH, —CH₂COOCH₃ and —CH₂CONH₂ are lower by a few tens of kaysers (cm⁻¹) than those of —CF₂H, —COF, —COOH free and —COOH bonded, —COOCH₃ and —CONH₂ shown in the Table, respectively.

For example, the number of the functional group —COF is the total of the number of a functional group determined from an absorption peak having an absorption frequency of 1,883 cm⁻¹ derived from —CF₂COF and the number of a functional group determined from an absorption peak having an absorption frequency of 1,840 cm⁻¹ derived from —CH₂COF.

The functional groups are ones present on main chain terminals or side chain terminals of the copolymer, and ones present in the main chain or the side chains. The number of the functional groups may be the total of numbers of —CF═CF₂, —CF₂H, —COF, —COOH, —COOCH₃, —CONH₂ and —CH₂OH.

The functional groups are introduced to the copolymer by, for example, a chain transfer agent or a polymerization initiator used for production of the copolymer. For example, in the case of using an alcohol as the chain transfer agent, or a peroxide having a structure of —CH₂OH as the polymerization initiator, —CH₂OH is introduced on the main chain terminals of the copolymer.

Alternatively, the functional group is introduced on the side chain terminal of the copolymer by polymerizing a monomer having the functional group.

By subjecting the copolymer having such a functional group to a fluorination treatment, the copolymer having the number of functional groups within the above range can be obtained. That is, the copolymer of the present disclosure is preferably one which is subjected to the fluorination treatment. Further, the copolymer of the present disclosure preferably has —CF₃ terminal groups.

The melting point of the copolymer is preferably 295 to 315° C., more preferably 300° C. or higher, still more preferably 303° C. or higher, especially preferably 304° C. or higher, and most preferably 305° C. or higher, and is more preferably 310° C. or lower. Due to that the melting point is in the above range, there can be obtained the copolymer giving formed articles better in the sealability particularly at high temperatures.

In the present disclosure, the melting point can be measured by using a differential scanning calorimeter [DSC].

The water vapor permeability of the copolymer is preferably 8.0 g·cm/m² or less. Due to that the content of the PPVE unit, the melt flow rate (MFR), and the number of functional groups of the copolymer containing the TFE unit and the PPVE unit are suitably regulated, the copolymer of the present disclosure has extremely good water vapor low permeability. Accordingly, water hardly permeates the formed article formed from the copolymer and, thus, the formed article when used as a wafer carrier can suppress contamination of wafers resulting from migration of contaminants from the wafer carrier.

In the present disclosure, the water vapor permeability can be measured under the condition of a temperature of 95° C. and for 30 days. Specific measurement of the water vapor permeability can be carried out by a method described in the Examples.

The nitrogen permeability coefficient of the copolymer is preferably 240 cm³·mm/(m²·24 h·atm) or less. Due to that the content of the PPVE unit, the melt flow rate (MFR), and the number of functional groups of the copolymer containing the TFE unit and the PPVE unit are suitably regulated, the copolymer of the present disclosure has excellent nitrogen low permeability.

In the present disclosure, the nitrogen permeability coefficient can be measured under the condition of a temperature of 70° C. and a test humidity of 0% RH. Specific measurement of the nitrogen permeability coefficient can be carried out by a method described in the Examples.

The methyl ethyl ketone (MEK) permeability of the copolymer is preferably 58.0 mg·cm/m²·day or less. Due to that the content of the PPVE unit, the melt flow rate (MFR), and the number of functional groups of the copolymer containing the TFE unit and the PPVE unit are suitably regulated, the copolymer of the present disclosure has excellent low MEK permeability. That is, by using the copolymer of the present disclosure, a formed article that hardly makes a chemical solution such as MEK to permeate can be obtained.

In the present disclosure, the MEK permeability can be measured under the condition of a temperature of 60° C. and for 60 days. Specific measurement of the MEK permeability can be carried out by a method described in the Examples.

The storage elastic modulus (E′) at 150° C. of the copolymer is preferably 115 MPa or higher, more preferably 120 MPa or higher and still more preferably 125 MPa or higher, and is preferably 1,000 MPa or lower, more preferably 500 MPa or lower and still more preferably 300 MPa or lower. Due to that the storage elastic modulus (E′) at 150° C. of the copolymer is in the above range, there can be obtained the copolymer giving formed articles that hardly deforms even at high temperatures.

The storage elastic modulus (E′) can be measured by carrying out dynamic viscoelasticity measurement under the condition of a temperature-increasing rate of 2° C./min, a frequency of 10 Hz, and a temperature in the range of 30 to 250° C. The storage elastic modulus (E′) at 150° C. can be raised by regulating the content of the PPVE unit and the melt flow rate (MFR) of the copolymer.

The resilience of the copolymer at 150° C. is preferably 0.55 MPa or higher, more preferably 0.60 MPa or higher, still more preferably 0.65 MPa or higher, further preferably 0.70 MPa or higher, still further preferably 0.75 MPa or higher, especially preferably 0.80 MPa or higher and most preferably 0.85 MPa or higher, and the upper limit is not limited and may be 3.00 MPa or lower. The resilience at 150° C. of the copolymer can be raised by regulating the content of the PPVE unit, the melt flow rate (MFR), and the number of functional groups of the copolymer. High resilience means that the formed article formed from the copolymer hardly deforms even at high temperatures.

The resilience can be determined as follows. A test piece obtained from the copolymer is deformed at a compression deformation rate of 50%, allowed to stand as is at 150° C. for 18 hours, released from the compressed state and allowed to stand at room temperature for 30 min, and thereafter, the height of the test piece (height of the test piece after being compressively deformed) is measured; and the resilience can be calculated by the following formula using the height of the test piece after being compressively deformed, and the storage elastic modulus (MPa) at 150° C.

resilience at 150° C. (MPa)=(t₂−t₁)/t₁×E′
t₁: an original height (mm) of a test piece before being compressively deformed×50%
t₂: a height (mm) of the test piece after being compressively deformed
E′: a storage elastic modulus (MPa) at 150° C.

The copolymer of the present disclosure can be produced by a polymerization method such as suspension polymerization, solution polymerization, emulsion polymerization or bulk polymerization. The polymerization method is preferably emulsion polymerization or suspension polymerization. In these polymerization methods, conditions such as temperature and pressure, and a polymerization initiator and other additives can suitably be set depending on the formulation and the amount of the copolymer.

As the polymerization initiator, an oil-soluble radical polymerization initiator, or a water-soluble radical polymerization initiator may be used.

The oil-soluble radical polymerization initiator may be a known oil-soluble peroxide, and examples thereof typically include:
dialkyl peroxycarbonates such as di-n-propyl peroxydicarbonate, diisopropyl peroxydicarbonate, di-sec-butyl peroxydicarbonate and di-2-ethoxyethyl peroxydicarbonate;
peroxyesters such as t-butyl peroxyisobutyrate and t-butyl peroxypivalate;
dialkyl peroxides such as di-t-butyl peroxide; and
di[fluoro(or fluorochloro)acyl]peroxides.

The di[fluoro(or fluorochloro)acyl]peroxides include diacyl peroxides represented by [(RfCOO)—]₂ wherein Rf is a perfluoroalkyl group, an ω-hydroperfluoroalkyl group, or a fluorochloroalkyl group.

Examples of the di[fluoro(or fluorochloro)acyl]peroxides include di(ω-hydro-dodecafluorohexanoyl) peroxide, di(ω-hydro-tetradecafluoroheptanoyl) peroxide, di(ω-hydro-hexadecafluorononanoyl) peroxide, di(perfluoropropionyl) peroxide, di(perfluorobutyryl) peroxide, di(perfluorovaleryl) peroxide, di(perfluorohexanoyl) peroxide, di(perfluoroheptanoyl) peroxide, di(perfluorooctanoyl) peroxide, di(perfluorononanoyl) peroxide, di(ω-chloro-hexafluorobutyryl) peroxide, di(ω-chloro-decafluorohexanoyl) peroxide, di(ω-chloro-tetradecafluorooctanoyl) peroxide, ω-hydrodo-decafluoroheptanoyl-ω-hydrohexadecafluorononanoyl peroxide, ω-chloro-hexafluorobutyryl-ω-chloro-decafluorohexanoyl peroxide, ω-hydrododecafluoroheptanoyl-perfluorobutyryl peroxide, di(dichloropentafluorobutanoyl) peroxide, di(trichlorooctafluorohexanoyl) peroxide, di(tetrachloroundecafluorooctanoyl) peroxide, di(pentachlorotetradecafluorodecanoyl) peroxide, and di(undecachlorotriacontafluorodocosanoyl) peroxide.

The water-soluble radical polymerization initiator may be a known water-soluble peroxide, and examples thereof include ammonium salts, potassium salts and sodium salts of persulfuric acid, perboric acid, perchloric acid, perphosphoric acid, percarbonic acid and the like, organic peroxides such as disuccinoyl peroxide and diglutaroyl peroxide, and t-butyl permaleate and t-butyl hydroperoxide. A reductant such as a sulfite salt may be combined with a peroxide and used, and the amount thereof to be used may be 0.1 to 20 times with respect to the peroxide.

In the polymerization, a surfactant, a chain transfer agent and a solvent may be used, which are conventionally known.

The surfactant may be a known surfactant, for example, nonionic surfactants, anionic surfactants and cationic surfactants may be used. Among these, fluorine-containing anionic surfactants are preferred, and more preferred are linear or branched fluorine-containing anionic surfactants having 4 to 20 carbon atoms, which may contain an ether bond oxygen (that is, an oxygen atom may be inserted between carbon atoms). The amount of the surfactant to be added (with respect to water in the polymerization) is preferably 50 to 5,000 ppm.

Examples of the chain transfer agent include hydrocarbons such as ethane, isopentane, n-hexane, and cyclohexane; aromatics such as toluene and xylene; ketones such as acetone; acetate esters such as ethyl acetate and butyl acetate; alcohols such as methanol and ethanol; mercaptans such as methylmercaptan; and halogenated hydrocarbons such as carbon tetrachloride, chloroform, methylene chloride and methyl chloride. The amount of the chain transfer agent to be added may vary depending on the chain transfer constant value of the compound to be used, but is usually in the range of 0.01 to 20% by mass with respect to the solvent in the polymerization.

The solvent may include water and mixed solvents of water and an alcohol.

In the suspension polymerization, in addition to water, a fluorinated solvent may be used. The fluorosolvent may include hydrochlorofluoroalkanes such as CH₃CClF₂, CH₃CCl₂F, CF₃CF₂CCl₂H and CF₂ClCF₂CFHCl; chlorofluoroalaknes such as CF₂ClCFClCF₂CF₃ and CF₃CFClCFClCF₃; hydrofluroalkanes such as CF₃CFHCFHCF₂CF₂CF₃, CF₂HCF₂CF₂CF₂CF₂H and CF₃CF₂CF₂CF₂CF₂CF₂CF₂H; hydrofluoroethers such as CH₃OC₂F₅, CH₃OC₃F₅CF₃CF₂CH₂OCHF₂, CF₃CHFCF₂OCH₃, CHF₂CF₂OCH₂F, (CF₃)₂CHCF₂OCH₃, CF₃CF₂CH₂OCH₂CHF₂ and CF₃CHFCF₂OCH₂CF₃; and perfluoroalkanes such as perfluorocyclobutane, CF₃CF₂CF₂CF₃, CF₃CF₂CF₂CF₂CF₃ and CF₃CF₂CF₂CF₂CF₂CF₃, and among these, perfluoroalkanes are preferred. The amount of the fluorosolvent to be used is, from the viewpoint of suspensibility and the economic efficiency, preferably 10 to 100% by mass with respect to an aqueous medium.

The polymerization temperature is not limited, and may be 0 to 100° C. The polymerization pressure is suitably set depending on other polymerization conditions to be used such as the kind, the amount, and the vapor pressure of the solvent, and the polymerization temperature, but may usually be 0 to 9.8 MPaG.

In the case of obtaining an aqueous dispersion containing the copolymer by the polymerization reaction, the copolymer can be recovered by coagulating, washing and drying the copolymer contained in the aqueous dispersion. Then in the case of obtaining the copolymer as a slurry by the polymerization reaction, the copolymer can be recovered by taking out the slurry from a reaction container, and washing and drying the slurry. The copolymer can be recovered in the shape of powder by the drying.

The copolymer obtained by the polymerization may be formed into pellets. A method of forming into pellets is not limited, and a conventionally known method can be used. Examples thereof include methods of melt extruding the copolymer by using a single-screw extruder, a twin-screw extruder or a tandem extruder and cutting the resultant into a predetermined length to form the copolymer into pellets. The extrusion temperature in the melt extrusion needs to be varied depending on the melt viscosity and the production method of the copolymer, and is preferably the melting point of the copolymer +° C. to the melting point of the copolymer+140° C. A method of cutting the copolymer is not limited, and a conventionally known method can be adopted such as a strand cut method, a hot cut method, an underwater cut method, or a sheet cut method. Volatile components in the obtained pellets may be removed by heating the pellets (degassing treatment). Alternatively, the obtained pellets may be treated by bringing the pellets into contact with hot water at 30 to 200° C., steam at 100 to 200° C. or hot air at 40 to 200° C.

Alternatively, the copolymer obtained by the polymerization may be subjected to fluorination treatment. The fluorination treatment can be carried out by bringing the copolymer having been subjected to no fluorination treatment into contact with a fluorine-containing compound. By the fluorination treatment, thermally unstable functional groups of the copolymer, such as —COOH, —COOCH₃, —CH₂OH, —COF, —CF═CF₂ and —CONH₂, and thermally relatively stable functional groups thereof, such as —CF₂H, can be converted to thermally very stable —CF₃. Consequently, the total number (number of functional groups) of —COOH, —COOCH₃, —CH₂OH, —COF, —CF═CF₂, —CONH₂ and —CF₂H of the copolymer can easily be controlled in the above-mentioned range.

The fluorine-containing compound is not limited, but includes fluorine radical sources generating fluorine radicals under the fluorination treatment condition. The fluorine radical sources include F₂ gas, CoF₃, AgF₂, UF₆, OF₂, N₂F₂, CF₃OF, and halogen fluorides (for example, IF₅ and ClF₃).

The fluorine radical source such as F₂ gas may be, for example, one having a concentration of 100%, but from the viewpoint of safety, the fluorine radical source is preferably mixed with an inert gas and diluted therewith to 5 to 50% by mass, and then used; and it is more preferably to be diluted to 15 to 30% by mass. The inert gas include nitrogen gas, helium gas and argon gas, but from the viewpoint of the economic efficiency, nitrogen gas is preferred.

The condition of the fluorination treatment is not limited, and the copolymer in a melted state may be brought into contact with the fluorine-containing compound, but the fluorination treatment can be carried out usually at a temperature of not higher than the melting point of the copolymer, preferably at 20 to 240° C. and more preferably at 100 to 220° C. The fluorination treatment is carried out usually for 1 to 30 hours and preferably 5 to 25 hours. The fluorination treatment is preferred which brings the copolymer having been subjected to no fluorination treatment into contact with fluorine gas (F₂ gas).

A composition may be obtained by mixing the copolymer of the present disclosure and as required, other components. The other components include fillers, plasticizers, processing aids, mold release agents, pigments, flame retarders, lubricants, light stabilizers, weathering stabilizers, electrically conductive agents, antistatic agents, ultraviolet absorbents, antioxidants, foaming agents, perfumes, oils, softening agents and dehydrofluorination agents.

Examples of the fillers include silica, kaolin, clay, organo clay, talc, mica, alumina, calcium carbonate, calcium terephthalate, titanium oxide, calcium phosphate, calcium fluoride, lithium fluoride, crosslinked polystyrene, potassium titanate, carbon, boron nitride, carbon nanotube, and glass fiber. The electrically conductive agents include carbon black. The plasticizers include dioctyl phthalate and pentaerythritol. The processing aids include carnauba wax, sulfone compounds, low molecular weight polyethylene and fluorine-based auxiliary agents. The dehydrofluorination agents include organic oniums and amidines.

As the above-mentioned other components, other copolymers other than the copolymer may be used. The other polymers include fluororesins other than the copolymer, fluoroelastomer, and non-fluorinated polymers.

A method of producing the composition includes a method of dry mixing the copolymer and the other components, and a method of previously mixing the copolymer and the other components by a mixer and then melt kneading the mixture by a kneader, melt extruder or the like.

The copolymer of the present disclosure or the above-mentioned composition can be used as a processing aid, a forming material and the like, and is suitably used as a forming material. There can also be utilized aqueous dispersions, solutions and suspensions of the copolymer of the present disclosure, and the copolymer/solvent-based materials; and these can be used for application of coating materials, encapsulation, impregnation, and casting of films. However, since the copolymer of the present disclosure has the above-mentioned properties, it is preferable to use the copolymer as the forming material.

Formed articles may be obtained by forming the copolymer of the present disclosure or the above composition.

A method of forming the copolymer or the composition is not limited, and includes injection molding, extrusion forming, compression molding, blow molding, transfer molding, rotomolding, and rotolining molding. As the forming method, among these, preferable are extrusion forming, compression molding, injection molding and transfer molding; more preferable are injection molding, extrusion forming and transfer molding from the viewpoint of being able to produce forming articles in a high productivity, and still more preferable is injection molding. That is, it is preferable that formed articles are extrusion formed articles, compression molded articles, injection molded articles or transfer molded articles; and from the viewpoint of being able to produce molded articles in a high productivity, being injection molded articles, extrusion formed articles or transfer molded articles is more preferable, and being injection molded articles is still more preferable. By forming the copolymer of the present disclosure by injection molding, an injection molded article having excellent surface smoothness can be obtained in a high productivity.

The formed article containing the copolymer of the present disclosure may be, for example, a nut, a bolt, a joint, a film, a bottle, a gasket, an electric wire coating, a tube, a hose, a pipe, a valve, a sheet, a seal, a packing, a tank, a roller, a container, a cock, a connector, a filter housing, a filter cage, a flow meter, a pump, a wafer carrier, and a wafer box.

The copolymer of the present disclosure, the above composition and the above formed article can be used, for example, in the following applications.
Food packaging films, and members for liquid transfer for food production apparatuses, such as lining materials of fluid transfer lines, packings, sealing materials and sheets, used in food production processes;
chemical stoppers and packaging films for chemicals, and members for chemical solution transfer, such as lining materials of liquid transfer lines, packings, sealing materials and sheets, used in chemical production processes;
inner surface lining materials of chemical solution tanks and piping of chemical plants and semiconductor factories;
members for fuel transfer, such as O (square) rings, tubes, packings, valve stem materials, hoses and sealing materials, used in fuel systems and peripheral equipment of automobiles, and such as hoses and sealing materials, used in ATs of automobiles;
members used in engines and peripheral equipment of automobiles, such as flange gaskets of carburetors, shaft seals, valve stem seals, sealing materials and hoses, and other vehicular members such as brake hoses, hoses for air conditioners, hoses for radiators, and electric wire coating materials;
members for chemical transfer for semiconductor production apparatuses, such as O (square) rings, tubes, packings, valve stem materials, hoses, sealing materials, rolls, gaskets, diaphragms and joints;
members for coating and inks, such as coating rolls, hoses and tubes, for coating facilities, and containers for inks;
members for food and beverage transfer, such as tubes, hoses, belts, packings and joints for food and beverage, food packaging materials, and members for glass cooking appliances;
members for waste liquid transport, such as tubes and hoses for waste transport;
members for high-temperature liquid transport, such as tubes and hoses for high-temperature liquid transport;
members for steam piping, such as tubes and hoses for steam piping; corrosion proof tapes for piping, such as tapes wound on piping of decks and the like of ships;
various coating materials, such as electric wire coating materials, optical fiber coating materials, and transparent front side coating materials installed on the light incident side and back side lining materials of photoelectromotive elements of solar cells;
diaphragms and sliding members such as various types of packings of diaphragm pumps;
films for agriculture, and weathering covers for various kinds of roof materials, sidewalls and the like;
interior materials used in the building field, and coating materials for glasses such as non-flammable fireproof safety glasses; and lining materials for laminate steel sheets used in the household electric field.

The fuel transfer members used in fuel systems of automobiles further include fuel hoses, filler hoses, and evap hoses. The above fuel transfer members can also be used as fuel transfer members for gasoline additive-containing fuels, resultant to sour gasoline, resistant to alcohols, and resultant to methyl tertiary butyl ether and amines and the like.

The above chemical stoppers and packaging films for chemicals have excellent chemical resistance to acids and the like. The above chemical solution transfer members also include corrosion-proof tapes wound on chemical plant pipes.

The above formed articles also include vehicular radiator tanks, chemical solution tanks, bellows, spacers, rollers and gasoline tanks, waste solution transport containers, high-temperature liquid transport containers and fishery and fish farming tanks.

The above formed articles further include members used for vehicular bumpers, door trims and instrument panels, food processing apparatuses, cooking devices, water- and oil-repellent glasses, illumination-related apparatuses, display boards and housings of OA devices, electrically illuminated billboards, displays, liquid crystal displays, cell phones, printed circuit boards, electric and electronic components, sundry goods, dust bins, bathtubs, unit baths, ventilating fans, illumination frames and the like.

Due to that the formed articles containing the copolymer of the present disclosure have extremely good water vapor low permeability, have excellent 150° C. abrasion resistance, nitrogen low permeability, chemical solution low permeability, high-temperature tensile creep property, deterioration resistance against repetitive load, high-temperature rigidity, and ozone resistance, hardly deform at high temperatures, hardly crack even when brought into contact with a chemical, hardly make fluorine ions to dissolve out in a chemical solution such as a hydrogen peroxide solution, the formed articles can suitably be utilized as a nut, a bolt, a joint, a packing, a valve, a cock, a connector, a filter housing, a filter cage, a flow meter, a pump, or the like.

Due to that the formed articles containing the copolymer of the present disclosure have extremely good water vapor low permeability, have excellent 150° C. abrasion resistance, nitrogen low permeability, chemical solution low permeability, high-temperature tensile creep property, deterioration resistance against repetitive load, high-temperature rigidity, and ozone resistance, hardly deform at high temperatures, hardly crack even when brought into contact with a chemical, hardly make fluorine ions to dissolve out in a chemical solution such as a hydrogen peroxide solution, the formed articles can suitably be utilized as a member to be compressed such as a gasket or a packing.

The members to be compressed of the present disclosure, even when being deformed at a high compression deformation rate, exhibit high resilience. The members to be compressed of the present disclosure can be used in a state of being compressed at a compression deformation rate of 10% or higher, and can be used in a state of being compressed at a compression deformation rate of 20% or higher or 25% or higher. By using the members to be compressed of the present disclosure by being deformed at such a high compression deformation rate, a certain rebound resilience can be retained for a long term and the sealing property and the insulating property can be retained for a long term.

The members to be compressed of the present disclosure, even when being deformed at a high temperature and at a high compression deformation rate, exhibit a high storage elastic modulus, a large amount of recovery, and high resilience. The members to be compressed of the present disclosure can be used at 150° C. or higher and in a state of being compression deformed at a compression deformation rate of 10% or higher, and can be used at 150° C. or higher and in a state of being compression deformed at a compression deformation rate of 20% or higher or 25% or higher. By using the members to be compressed of the present disclosure by being deformed at such a high temperature and at such a high compression deformation rate, a certain rebound resilience can be retained also at high temperatures for a long term, and the sealing property and the insulating property at high temperatures can be retained for a long term.

In the case where the members to be compressed are used in a state of being compressed, the compression deformation rate is a compression deformation rate of a portion having the highest compression deformation rate. For example, in the case where a flat member to be compressed is used in a state of being compressed in the thickness direction, the compression deformation rate is that in the thickness direction. Further for example, in the case where a member to be compressed is used with only some portions of the member in a state of being compressed, the compression deformation rate is that of a portion having the highest compression deformation rate among compression deformation rates of the compressed portions.

The size and shape of the members to be compressed of the present disclosure may suitably be set according to applications, and are not limited. The shape of the members to be compressed of the present disclosure may be, for example, annular. The members to be compressed of the present disclosure may also have, in plan view, a circular shape, an elliptic shape, a corner-rounded square or the like, and may be a shape having a throughhole in the central portion thereof.

It is preferable that the members to be compressed of the present disclosure are used as members constituting non-aqueous electrolyte batteries. Due to that the members to be compressed of the present disclosure have extremely good water vapor low permeability, have excellent 150° C. high-temperature rigidity, nitrogen low permeability, chemical solution low permeability, high-temperature tensile creep property, deterioration resistance against repetitive load, high-temperature rigidity, and ozone resistance, have extremely good high-temperature sealability, the members are especially suitable as a members used in a state of being in contact with a non-aqueous electrolyte in the non-aqueous electrolyte batteries. That is, the members to be compressed of the present disclosure may also be ones having a liquid-contact surface with a non-aqueous electrolyte in the non-aqueous electrolyte batteries.

The members to be compressed of the present disclosure hardly make water vapor to penetrate. Therefore, by using the members to be compressed of the present disclosure, the permeation of water vapor from the outside to secondary batteries can be suppressed. Consequently, by using the members to be compressed of the present disclosure, the deterioration of the battery performance and the shortening of the service life of the non-aqueous electrolyte batteries can be suppressed.

The water vapor permeability of the member to be compressed of the present disclosure is, from the viewpoint that the deterioration and the shortening of the service life of the battery performance of the non-aqueous electrolyte battery can be more suppressed, preferably 8.8 g·cm/m² or lower, more preferably 8.4 g·cm/m² or lower, and still more preferably 8.0 g·cm/m² or lower. The water vapor permeability of the members to be compressed can be measured under the condition of a temperature of 95° C. and for 30 days.

The non-aqueous electrolyte batteries are not limited as long as being batteries having a non-aqueous electrolyte, and examples include lithium ion secondary batteries and lithium ion capacitors. Members constituting the non-aqueous electrolyte batteries include sealing members and insulating members.

For the non-aqueous electrolyte, one or two or more of well-known solvents can be used such as propylene carbonate, ethylene carbonate, butylene carbonate, γ-butyllactone, 1,2-dimethoxyethane, 1,2-diethoxyethane, dimethyl carbonate, diethyl carbonate and ethyl methyl carbonate. The non-aqueous electrolyte batteries may further have an electrolyte. The electrolyte is not limited, and may be LiClO₄, LiAsF₆, LiPF₆, LiBF₄, LiCl, LiBr, CH₃SO₃Li, CF₃SO₃Li, cesium carbonate and the like.

The members to be compressed of the present disclosure can suitably be utilized, for example, as sealing members such as sealing gaskets or sealing packings, and insulating members such as insulating gaskets and insulating packings. The sealing members are members to be used for preventing leakage of a liquid or a gas, or penetration of a liquid or a gas from the outside. The insulating member are members to be used for insulating electricity. The members to be compressed of the present disclosure may also be members to be used for the purpose of both of sealing and insulation.

Due to that the members to be compressed of the present disclosure exhibit a high compression deformation rate, a high storage elastic modulus, a large amount of recovery, and high resilience, even when being deformed at high temperatures, can suitably be used under an environment of becoming high temperatures. It is suitable for the members to be compressed of the present disclosure to be used, for example, in an environment where the maximum temperature becomes 40° C. or higher. It is suitable for the members to be compressed of the present disclosure to be used, for example, in an environment where the maximum temperature becomes 150° C. or higher. Examples of the case where the temperature of the members to be compressed of the present disclosure may become such high temperatures include the case where after a member to be compressed is installed in a state of being compressed to a battery, other battery members are installed to the battery by welding, and the case where a non-aqueous electrolyte battery generates heat.

Due to that the members to be compressed of the present disclosure have extremely good water vapor low permeability and, even when being deformed at a high temperature and at a high compression deformation rate, exhibits a high storage elastic modulus, a large amount of recovery, and high resilience, can suitably be used as sealing members for non-aqueous electrolyte batteries or insulating members for a non-aqueous electrolyte batteries. For example, in the charging of batteries such as non-aqueous electrolyte secondary batteries, the temperature of the batteries temporarily becomes 40° C. or higher, specially may temporarily become 150° C. or higher in some cases. Even when the members to be compressed of the present disclosure are used by being deformed at high temperatures and at a high compression deformation rate, and moreover are brought into contact with non-aqueous electrolytes at high temperatures, in batteries such as non-aqueous electrolyte batteries, a high rebound resilience is not impaired. Therefore, the members to be compressed of the present disclosure, in the case of being used as sealing members, have excellent sealing property and also at high temperatures, and retain the sealing property for a long term. Further, the members to be compressed of the present disclosure, due to containing the above copolymer, have excellent insulating properties. Therefore, in the case of using the member to be compressed of the present disclosure as insulating members, the members firmly adhere to two or more electrically conductive members and prevent short circuit over a long term.

By forming the copolymer of the present disclosure by extrusion forming, a thin coating layer can be formed on a core wire having a small diameter at a high take-over speed without discontinuity of the coating even when the diameter of the core wire is small, also a coating layer having excellent electric property can be formed, and thus the copolymer of the present disclosure can be utilized as a material for forming an electric wire coating. Accordingly, a coated electric wire provided with a coating layer containing the copolymer of the present disclosure also has excellent electric property because the coated electric wire barely has defects that cause sparks even when the diameter of the core wire is small and the coating layer is thin.

The coated electric wire has a core wire, and the coating layer installed on the periphery of the core wire and containing the copolymer of the present disclosure. For example, an extrusion formed article made by melt extruding the copolymer of the present disclosure on a core wire can be made into the coating layer. The coated electric wires are suitable to LAN cables (Ethernet cables), high-frequency transmission cables, flat cables, heat-resistant cables and the like, and particularly, to transmission cables such as LAN cables (Ethernet cables) and high-frequency transmission cables.

As a material for the core wire, for example, a metal conductor material such as copper or aluminum can be used. The core wire is preferably one having a diameter of 0.02 to 3 mm. The diameter of the core wire is more preferably 0.04 mm or larger, still more preferably 0.05 mm or larger and especially preferably 0.1 mm or larger. The diameter of the core wire is more preferable 2 mm or smaller.

With regard to specific examples of the core wire, there may be used, for example, AWG (American Wire Gauge)—46 (solid copper wire of 40 μm in diameter), AWG-26 (solid copper wire of 404 μm in diameter), AWG-24 (solid copper wire of 510 μm in diameter), and AWG-22 (solid copper wire of 635 μm in diameter).

The coating layer is preferably one having a thickness of 0.1 to 3.0 mm. It is also preferable that the thickness of the coating layer is 2.0 mm or smaller.

The high-frequency transmission cables include coaxial cables. The coaxial cables generally have a structure configured by laminating an inner conductor, an insulating coating layer, an outer conductor layer and a protective coating layer in order from the core part to the peripheral part. A formed article containing the copolymer of the present disclosure can suitably be utilized as the insulating coating layer containing the copolymer. The thickness of each layer in the above structure is not limited, but is usually: the diameter of the inner conductor is approximately 0.1 to 3 mm; the thickness of the insulating coating layer is approximately 0.3 to 3 mm; the thickness of the outer conductor layer is approximately 0.5 to 10 mm; and the thickness of the protective coating layer is approximately 0.5 to 2 mm.

Alternatively, the coating layer may be one containing cells, and is preferably one in which cells are homogeneously distributed.

The average cell size of the cells is not limited, but is, for example, preferably 60 μm or smaller, more preferably 45 μm or smaller, still more preferably 35 μm or smaller, further still more preferably 30 μm or smaller, especially preferably 25 μm or smaller and further especially preferably 23 μm or smaller. Then, the average cell size is preferably 0.1 μm or larger and more preferably 1 μm or larger. The average cell size can be determined by taking an electron microscopic image of an electric wire cross section, calculating the diameter of each cell and averaging the diameters.

The foaming ratio of the coating layer may be 20% or higher, and is more preferably 30% or higher, still more preferably 33% or higher and further still more preferably 35% or higher. The upper limit is not limited, but is, for example, 80%. The upper limit of the foaming ratio may be 60%. The foaming ratio is a value determined as ((the specific gravity of an electric wire coating material−the specific gravity of the coating layer)/(the specific gravity of the electric wire coating material)×100. The foaming ratio can suitably be regulated according to applications, for example, by regulation of the amount of a gas, described later, to be injected in an extruder, or by selection of the kind of a gas dissolving.

Alternatively, the coated electric wire may have another layer between the core wire and the coating layer, and may further have another layer (outer layer) on the periphery of the coating layer. In the case where the coating layer contains cells, the electric wire of the present disclosure may be of a two-layer structure (skin-foam) in which a non-foaming layer is inserted between the core wire and the coating layer, a two-layer structure (foam-skin) in which a non-foaming layer is coated as the outer layer, or a three-layer structure (skin-foam-skin) in which a non-foaming layer is coated as the outer layer of the skin-foam structure. The non-foaming layer is not limited, and may be a resin layer composed of a resin, such as a TFE/HFP-based copolymer, a TFE/PAVE copolymer, a TFE/ethylene-based copolymer, a vinylidene fluoride-based polymer, a polyolefin resin such as polyethylene [PE], or polyvinyl chloride [PVC].

The coated electric wire can be produced, for example, by using an extruder, heating the copolymer, extruding the copolymer in a molten state on the core wire to thereby form the coating layer.

In formation of a coating layer, by heating the copolymer and introducing a gas in the copolymer in a molten state, the coating layer containing cells can be formed. As the gas, for example, a gas such as chlorodifluoromethane, nitrogen or carbon dioxide, or a mixture thereof can be used. The gas may be introduced as a pressurized gas in the heated copolymer, or may be generated by mingling a chemical foaming agent in the copolymer. The gas dissolves in the copolymer in a molten state.

Also, the copolymer of the present disclosure can suitably be utilized as a material for products for high-frequency signal transmission.

The products for high-frequency signal transmission are not limited as long being products to be used for transmission of high-frequency signals, and include (1) formed boards such as insulating boards for high-frequency circuits, insulating materials for connection parts and printed circuit boards, (2) formed articles such as bases of high-frequency vacuum tubes and antenna covers, and (3) coated electric wires such as coaxial cables and LAN cables. The products for high-frequency signal transmission can suitably be used in devices utilizing microwaves, particularly microwaves of 3 to 30 GHz, in satellite communication devices, cell phone base stations, and the like.

In the products for high-frequency signal transmission, the copolymer of the present disclosure can suitably be used as an insulator in that the dielectric loss tangent is low.

As the (1) formed boards, printed wiring boards are preferable in that the good electric property is provided. The printed wiring boards are not limited, but examples thereof include printed wiring boards of electronic circuits for cell phones, various computers, communication devices and the like. As the (2) formed article, antenna covers are preferable in that the low dielectric loss is low.

By forming the copolymer of the present disclosure by injection molding, a sheet having excellent surface smoothness can be obtained in a high productivity. Also, the formed article containing the copolymer of the present disclosure has extremely good water vapor low permeability, has excellent 150° C. abrasion resistance, nitrogen low permeability, chemical solution low permeability, high-temperature tensile creep property, deterioration resistance against repetitive load, high-temperature rigidity, and ozone resistance, hardly deforms at high temperatures, hardly cracks even when brought into contact with a chemical, and hardly makes fluorine ions to dissolve out in a chemical solution such as a hydrogen peroxide solution. Accordingly, the formed article containing the copolymer of the present disclosure can suitably be utilized as a film or a sheet.

The film of the present disclosure is useful as release films. The release films can be produced by forming the copolymer of the present disclosure by melt extrusion, calendering, press molding, casting or the like. From the viewpoint that uniform thin films can be obtained, the release films can be produced by melt extrusion forming.

The films of the present disclosure can be applied to the surface of rolls used in OA devices. The copolymer of the present disclosure is formed into required shapes, such as sheets, films or tubes, by extrusion forming, compression molding, press molding or the like, and can be used as surface materials of OA device rolls, OA device belts and the like. Thin-wall tubes and films can be produced particularly by melt extrusion forming.

The formed article containing the copolymer of the present disclosure has extremely good water vapor low permeability, has excellent 150° C. abrasion resistance, nitrogen low permeability, chemical solution low permeability, high-temperature tensile creep property, deterioration resistance against repetitive load, high-temperature rigidity, and ozone resistance, hardly deforms at high temperatures, hardly cracks even when brought into contact with a chemical, hardly makes fluorine ions to dissolve out in a chemical solution such as a hydrogen peroxide solution, and thus can suitably be utilized as a bottle or a tube. The bottle or the tube of the present disclosure enables the contents to be easily viewed, and is hardly damaged during use.

The copolymer of the present disclosure is capable of forming an injection molded article in a high productivity by injection molding. Moreover, the obtained formed article has excellent surface smoothness, has extremely good water vapor low permeability, has excellent 150° C. abrasion resistance, nitrogen low permeability, chemical solution low permeability, high-temperature tensile creep property, deterioration resistance against repetitive load, high-temperature rigidity, and ozone resistance, hardly deforms at high temperatures, hardly cracks even when brought into contact with a chemical, hardly makes fluorine ions to dissolve out in a chemical solution such as a hydrogen peroxide solution, and thus can suitably be utilized as a valve. Accordingly, the valve containing the copolymer of the present disclosure can be produced in a high productivity, is also hardly damaged even when opened and closed highly frequently, and has excellent chemical solution low permeability, high-temperature sealability, and low water vapor permeablity. In the valve of the present disclosure, at least the fluid-contacting part can be constituted by the copolymer. Also, the valve of the present disclosure may be a valve having a housing containing the copolymer.

So far, embodiments have been described, but it is to be understood that various changes and modifications of patterns and details may be made without departing from the subject matter and the scope of the claims.

According to the present disclosure, there is provided a copolymer containing tetrafluoroethylene unit and perfluoro(propyl vinyl ether) unit, wherein the copolymer has a content of perfluoro(propyl vinyl ether) unit of 3.3 to 4.2% by mass with respect to the whole of the monomer units, a melt flow rate at 372° C. of 27.0 to 35.0 g/10 min, and the number of functional groups of 20 or less per 10⁶ main-chain carbon atoms.

The copolymer of the present disclosure preferably has a melt flow rate at 372° C. of 27.0 to 33.0 g/10 min.

According to the present disclosure, an injection molded article comprising the above copolymer is further provided.

According to the present disclosure, a coated electric wire having a coating layer comprising the above copolymer is further provided.

According to the present disclosure, a formed article comprising the above copolymer, wherein the formed article is a wafer carrier, a gasket, or an electric wire coating is further provided.

### EXAMPLES

The embodiments of the present disclosure will now be described by Examples as follows, but the present disclosure is not limited only to these Examples.

Each numerical values in Examples was measured by the following methods.

(Content of a Monomer Unit)

The content of each monomer unit was measured by an NMR analyzer (for example, manufactured by Bruker BioSpin GmbH, AVANCE 300, high-temperature probe).

(Melt Flow Rate (MFR))

The polymer was made to flow out from a nozzle having an inner diameter of 2.1 mm and a length of 8 mm at 372° C. under a load of 5 kg by using a Melt Indexer G-01 (manufactured by Toyo Seiki Seisaku-sho, Ltd.) according to ASTM D1238, and the mass (g/10 min) of the polymer flowing out per 10 min was determined.

(Number of Functional Groups)

Pellets of the copolymer was formed by cold press into a film of 0.25 to 0.30 mm in thickness. The film was 40 times scanned and analyzed by a Fourier transform infrared spectrometer [FT-IR (Spectrum One, manufactured by PerkinElmer, Inc.)] to obtain an infrared absorption spectrum, and a difference spectrum against a base spectrum that is completely fluorinated and has no functional groups is obtained. From an absorption peak of a specific functional group observed on this difference spectrum, the number N of the functional group per 1×10⁶ carbon atoms in the sample was calculated according to the following formula (A).

N=I×K/t (A)
I: absorbance
K: correction factor
t: thickness of film (mm)

For reference, the absorption frequency, the molar absorption coefficient and the correction factor of the functional groups in the present disclosure are shown in Table 2. The molar absorption coefficients are those determined from FT-IR measurement data of low molecular model compounds.

TABLE 2

| | | Molar | | |
|---|---|---|---|---|
| | Absorption | Extinction | | |
| Functional | Frequency | Coefficient | Correction | |
| Group | (cm⁻¹) | (l/cm/mol) | Factor | Model Compound |
| —COF | 1883 | 600 | 388 | C₇F₁₅COF |
| —COOH | 1815 | 530 | 439 | H(CF₂)₆COOH |
| free | | | | |
| —COOH | 1779 | 530 | 439 | H(CF₂)₆COOH |
| bonded | | | | |
| —COOCH₃ | 1795 | 680 | 342 | C₇F₁₅COOCH₃ |
| —CONH₂ | 3436 | 506 | 460 | C₇H₁₅CONH₂ |
| —CH₂OH₂, | 3648 | 104 | 2236 | C₇H₁₅CH₂OH |
| —OH | | | | |
| —CF₂H | 3020 | 8.8 | 26485 | H(CF₂CF₂)₃CH₂OH |
| —CF═CF₂ | 1795 | 635 | 366 | CF₂═CF₂ |

(Melting Point)

The polymer was heated, as a first temperature raising step, at a temperature-increasing rate of 10° C./min from 200° C. to 350° C., then cooled at a cooling rate of 10° C./min from 350° C. to 200° C., and then again heated, as second temperature raising step, at a temperature-increasing rate of 10° C./min from 200° C. to 350° C. by using a differential scanning calorimeter (trade name: X-DSC7000, manufactured by Hitachi High-Tech Science Corporation); and the melting point was determined from a melting curve peak observed in the second temperature raising step.

### Example 1

33.4 L of pure water was charged in a 174 L-volume autoclave; nitrogen replacement was sufficiently carried out; thereafter, 33.4 kg of perfluorocyclobutane, 0.83 kg of perfluoro(propyl vinyl ether) (PPVE) and 2.26 kg of methanol were charged; and the temperature in the system was held at 35° C. and the stirring speed was held at 200 rpm. Then, tetrafluoroethylene (TFE) was introduced under pressure up to 0.6 MPa, and thereafter 0.066 kg of a 50% methanol solution of di-n-propyl peroxydicarbonate was charged to initiate polymerization. Since the pressure in the system decreased along with the progress of the polymerization, TFE was continuously supplied to make the pressure constant, and 0.042 kg of PPVE was added for every 1 kg of TFE supplied and the polymerization was continued for 20.3 hours. TFE was released to return the pressure in the autoclave to the atmospheric pressure, and thereafter, an obtained reaction product was washed with water and dried to thereby obtain 33 kg of a powder.

The obtained powder was melt extruded at 360° C. by a screw extruder (trade name: PCM46, manufactured by Ikegai Corp) to thereby obtain pellets of a TFE/PPVE copolymer. The PPVE content of the obtained pellets was measured by the method described above. The results are shown in Table 3.

The obtained pellets were put in a vacuum vibration-type reactor VVD-30 (manufactured by OKAWARA MFG. CO., LTD.), and heated to 210° C. After vacuumizing, F₂ gas diluted to 20% by volume with N₂ gas was introduced to the atmospheric pressure. 0.5 hour after the F₂ gas introduction, vacuumizing was once carried out and F₂ gas was again introduced. Further, 0.5 hour thereafter, vacuumizing was again carried out and F₂ gas was again introduced. Thereafter, while the above operation of the F₂ gas introduction and the vacuumizing was carried out once every 1 hour, the reaction was carried out at a temperature of 210° C. for 10 hours. After the reaction was finished, the reactor interior was replaced sufficiently by N₂ gas to finish the fluorination reaction. By using the fluorinated pellets, the above physical properties were measured by the methods described above. The results are shown in Table 3.

### Example 2

Fluorinated pellets were obtained as in Example 1, except for changing the charged amount of PPVE to 0.80 kg, changing the charged amount of methanol to 2.42 kg, adding 0.041 kg of PPVE for every 1 kg of TFE supplied, and changing the polymerization time to 19.3 hours. The results are shown in Table 3.

### Example 3

34.0 L of pure water was charged in a 174 L-volume autoclave; nitrogen replacement was sufficiently carried out; thereafter, 30.4 kg of perfluorocyclobutane, 0.71 kg of perfluoro(propyl vinyl ether) (PPVE) and 2.05 kg of methanol were charged; and the temperature in the system was held at 35° C. and the stirring speed was held at 200 rpm. Then, tetrafluoroethylene (TFE) was introduced under pressure up to 0.6 MPa, and thereafter 0.060 kg of a 50% methanol solution of di-n-propyl peroxydicarbonate was charged to initiate polymerization. Since the pressure in the system decreased along with the progress of the polymerization, TFE was continuously supplied to make the pressure constant, and 0.040 kg of PPVE was added for every 1 kg of TFE supplied and the polymerization was continued for 18.5 hours. TFE was released to return the pressure in the autoclave to the atmospheric pressure, and thereafter, an obtained reaction product was washed with water and dried to thereby obtain 30 g of a powder.

The obtained powder was melt extruded at 360° C. by a screw extruder (trade name: PCM46, manufactured by Ikegai Corp) to thereby obtain pellets of a TFE/PPVE copolymer. The PPVE content of the obtained pellets was measured by the method described above. The results are shown in Table 3.

The obtained pellets were put in a vacuum vibration-type reactor VVD-30 (manufactured by OKAWARA MFG. CO., LTD.), and heated to 210° C. After vacuumizing, F₂ gas diluted to 20% by volume with N₂ gas was introduced to the atmospheric pressure. 0.5 hour after the F₂ gas introduction, vacuumizing was once carried out and F₂ gas was again introduced. Further, 0.5 hour thereafter, vacuumizing was again carried out and F₂ gas was again introduced. Thereafter, while the above operation of the F₂ gas introduction and the vacuumizing was carried out once every 1 hour, the reaction was carried out at a temperature of 210° C. for 10 hours. After the reaction was finished, the reactor interior was replaced sufficiently by N₂ gas to finish the fluorination reaction. By using the fluorinated pellets, the above physical properties were measured by the methods described above. The results are shown in Table 3.

### Example 4

Fluorinated pellets were obtained as in Example 3, except for changing the charged amount of PPVE to 0.68 kg, changing the charged amount of methanol to 1.85 kg, adding 0.038 kg of PPVE for every 1 kg of TFE supplied, and changing the polymerization time to 18 hours. The results are shown in Table 3.

### Example 5

Fluorinated pellets were obtained as in Example 3, except for changing the charged amount of PPVE to 0.66 kg, changing the charged amount of methanol to 1.80 kg, adding 0.037 kg of PPVE for every 1 kg of TFE supplied, and changing the polymerization time to 18 hours. The results are shown in Table 3.

### Example 6

Fluorinated pellets were obtained as in Example 3, except for changing the charged amount of PPVE to 0.63 kg, changing the charged amount of methanol to 1.90 kg, adding 0.036 kg of PPVE for every 1 kg of TFE supplied, and changing the polymerization time to 18 hours. The results are shown in Table 3.

### Comparative Example 1

51.8 L of pure water was charged in a 174 L-volume autoclave; nitrogen replacement was sufficiently carried out; thereafter, 40.9 kg of perfluorocyclobutane, 1.79 kg of perfluoro(propyl vinyl ether) (PPVE) and 6.61 kg of methanol were charged; and the temperature in the system was held at 35° C. and the stirring speed was held at 200 rpm. Then, tetrafluoroethylene (TFE) was introduced under pressure up to 0.64 MPa, and thereafter 0.051 kg of a 50% methanol solution of di-n-propyl peroxydicarbonate was charged to initiate polymerization. Since the pressure in the system decreased along with the progress of the polymerization, TFE was continuously supplied to make the pressure constant, and 0.042 kg of PPVE was additionally charged for every 1 kg of TFE supplied. The polymerization was finished at the time when the amount of TFE additionally charged reached 40.9 kg. Unreacted TFE was released to return the pressure in the autoclave to the atmospheric pressure, and thereafter, an obtained reaction product was washed with water and dried to thereby obtain 41.0 kg of a powder.

By using the obtained powder, the fluorination reaction was carried out as in Example 1 to give fluorinated pellets. The results are shown in Table 3.

### Comparative Example 2

Fluorinated pellets were obtained as in Example 3, except for changing the charged amount of PPVE to 0.73 kg, changing the charged amount of methanol to 3.49 kg, adding 0.040 kg of PPVE for every 1 kg of TFE supplied, and changing the polymerization time to 20 hours. The results are shown in Table 3.

### Comparative Example 3

Fluorinated pellets were obtained as in Example 3, except for changing the amount of pure water to 26.6 L, PPVE to 0.77 kg, and methanol to 5.10 kg, introducing TFE under pressure up to 0.58 MPa, adding 0.011 kg of a 50% methanol solution of di-n-propyl peroxydicarbonate, adding 0.031 kg of PPVE for every 1 kg of TFE supplied, and changing the polymerization time to 11 hours to obtain 15 kg of a dry powder. The results are shown in Table 3.

### Comparative Example 4

Fluorinated pellets were obtained as in Example 3, except for changing the amount of pure water to 26.6 L, PPVE to 1.40 kg, and methanol to 3.00 kg, introducing TFE under pressure up to 0.57 MPa, adding 0.014 kg of a 50% methanol solution of di-n-propyl peroxydicarbonate, adding 0.048 kg of PPVE for every 1 kg of TFE supplied, and changing the polymerization time to 21 hours. The results are shown in Table 3.

### Comparative Example 5

Fluorinated pellets were obtained as in Example 3, except for changing the charged amount of PPVE to 0.86 kg, changing the charged amount of methanol to 1.50 kg, adding 0.046 kg of PPVE for every 1 kg of TFE supplied, changing the polymerization time to 21 hours, changing the heating temperature of the vacuum vibration-type reactor to 160° C., and changing the reaction condition to 160° C. and 5 hours. The results are shown in Table 3.

TABLE 3

| | | | Number of | |
|---|---|---|---|---|
| | PPVE | | functional | Melting |
| | content | MER | groups | point |
| | (% by mass) | (g/10 min) | (groups/C10⁵) | (° C.) |
| Example 1 | 4.0 | 32.0 | <6 | 305 |
| Example 2 | 3.9 | 33.3 | <6 | 305 |
| Example 3 | 3.8 | 31.0 | <6 | 306 |
| Example 4 | 3.7 | 29.0 | <6 | 307 |
| Example 5 | 3.6 | 27.0 | <6 | 307 |
| Example 6 | 3.5 | 28.0 | <6 | 308 |
| Comparative | 4.0 | 25.0 | <6 | 305 |
| Example 1 | | | | |
| Comparative | 3.9 | 48.3 | <6 | 305 |
| Example 2 | | | | |
| Comparative | 3.0 | 29.0 | <6 | 310 |
| Example 3 | | | | |
| Comparative | 4.6 | 31.0 | <6 | 304 |
| Example 4 | | | | |
| Comparative | 4.4 | 29.0 | 42 | 304 |
| Example 5 | | | | |

The description “<6” in Table 3 means that the number of functional groups is less than 6.

Then, by using the obtained pellets, the following properties were evaluated. The results are shown in Table 4.

(Chemical Immersion Crack Test)

Approximately 50 g of the pellets was charged in a metal mold (inner diameter: 120 mm, height: 38 mm), and in that state, melted by hot plate press at 360° C. for 20 min, thereafter, water-cooled under a pressure of 1 MPa to thereby prepare a formed article of approximately 2 mm in thickness. The obtained sheet was punched out by using a rectangular dumbbell of 13.5 mm×38 mm to obtain 3 test pieces. A notch was formed in the middle of a long side of the each obtained test piece according to ASTM D1693 by a blade of 19 mm×0.45 mm. Three notched test pieces and 25 g of an aqueous 40% by mass tetrabutylammonium solution were put in a 100 mL polypropylene bottle, and heated in an electric furnace at 100° C. for 20 hours, and then the notched test pieces were taken out. Then, the three notched test pieces were attached to a stress crack test jig according to ASTM D1693, the notches and the surrounding portions were visually observed, and the number of cracks was counted.
Good: the number of cracks was 0
Poor: the number of cracks was 1 or more

(Water Vapor Permeability)

By using the pellets and a heat press molding machine, a sheet-shape test piece of approximately 0.2 mm in thickness was prepared. 18 g of water was put in a test cup (permeation area: 12.56 cm²), and the test cup was covered with the sheet-shape test piece; and a PTFE gasket was pinched and fastened to hermetically close the test cup. The sheet-shape test piece was brought into contact with the water, and held at a temperature of 95° C. for 30 days, and thereafter, the test cup was taken out and allowed to stand at room temperature for 2 hours; thereafter, the amount of the mass lost was measured. The water vapor permeability (g·cm/m²) was determined by the following formula.

Water vapor permeability (g·cm/m²)=the amount of the mass lost (g)×the thickness of the sheet-shape test piece (cm)/the permeation area (m²)

(Storage Elastic Modulus (E′))

The storage elastic modulus was determined by carrying out a dynamic viscoelasticity measurement using a DVA-220 (manufactured by IT Keisoku Seigyo K.K.). By using, as a sample test piece, a heat press molded sheet of 25 mm in length, 5 mm in width and 0.2 mm in thickness, the measurement was carried out under the condition of a temperature-increasing rate of 2° C./min, and a frequency of 10 Hz, and in a range of 30° C. to 250° C., the storage elastic modulus (MPa) at 150° C. was identified.

(Amount of Recovery)

The amount of recovery was measured according to the method described in ASTM D395 or JIS K6262:2013.

Approximately 2 g of the pellets was charged in a metal mold (inner diameter: 13 mm, height: 38 mm), and in that state, melted by hot plate press at 370° C. for 30 min, thereafter, water-cooled under a pressure of 0.2 MPa (resin pressure) to prepare a formed article Approximately 8 mm in height. Thereafter, the obtained molded article was cut to prepare a test piece of 13 mm in outer diameter and 6 mm in height. The prepared test piece was compressed to a compression deformation rate of 50% (that is, the test piece of 6 mm in height was compressed to a height of 3 mm) at a normal temperature by using a compression device. The compressed test piece being fixed on the compression device was allowed to stand still in an electric furnace at 150° C. for 18 hours. The compression device was taken out from the electric furnace, and cooled to room temperature; thereafter, the test piece was dismounted. The collected test piece was allowed to stand at room temperature for 30 min, and the height of the collected test piece was measured and the amount of recovery was determined by the following formula.

Amount of recovery(mm)=t₂−t₁
t₁: a height of a spacer (mm)
t₂: a height of the test piece dismounted from the compression device (mm)

In the above test, t₁ was 3 mm.

(Resilience at 150° C.)

The resilience at 150° C. was determined from the result of the compression set test at 150° C. and the result of the storage elastic modulus measurement at 150° C. by the following formula:

Resilience at 150° C. (MPa)=(t₂−t₁)/t₁×E′
t₁: the height of a spacer (mm)
t₂: the height of the test piece dismounted from the compression device (mm)
E′: a storage elastic modulus (MPa) at 150° C.

A formed article having a large 150° C. resilience hardly deforms even at high temperatures, and also has excellent high-temperature sealability.

(Injection Moldability)

The copolymer was injection molded by using an injection molding machine (SE50EV-A, manufactured by Sumitomo Heavy Industries, Ltd.) set at a cylinder temperature of 390° C., a metal mold temperature of 170° C., and an injection speed of 50 mm/s. A metal mold (100 mm×100 mm×2.5 mmt) obtained by Cr-plated HPM38 was used. The surface of the injection molded article was visually observed, and the surface smoothness was evaluated according to the following criteria.
2: no surface roughness was observed, and thus smooth
1: roughness was observed only on the surface of the portion in the vicinity of the gate of the metal mold
0: roughness was observed on the most of the surface

(Conditions for Forming Electric Wire Coating)

Extrusion coating in the following coating thickness was carried out on a copper conductor of 0.50 mm in conductor diameter by a 30-mmφ electric wire coating forming machine (manufactured by Tanabe Plastics Machinery Co., Ltd.), to thereby obtain a coated electric wire. The extrusion conditions for the electric wire coating were as follows.
a) Core conductor: 0.50 mm in conductor diameter
b) Coating thickness: 0.15 mm
c) Coated electric wire diameter: 0.80 mm
d) Electric wire take-over speed: 150 m/min
e) Extrusion condition:

Cylinder screw diameter=30 mm, a single-screw extruder of L/D=22

Die (inner diameter)/tip (outer diameter)=8.0 mm/5.0 mm
Set temperature of extruder: barrel section C-1 (330° C.), barrel section C-2 (360° C.), barrel section C-3 (375° C.), head section H (390° C.), die section D-1 (405° C.), die section D-2 (395° C.). Set temperature for preheating core wire: 80° C.

(Spark)

A spark tester (DENSOK HIGH FREQ SPARK TESTER) was installed online on an electric wire coating line, and the presence/absence of defects of the electric wire coating was evaluated at a voltage of 1,500 V. The case where no spark was generated in 1-hour continuous forming was determined as passing (Good), and the case where a spark was detected therein was determined as rejected (Poor).

(Coating Discontinuity)

Electric wire coating forming was continuously carried out; and the case where coating discontinuity occurred once or more in 1 hour was determined as poor (Poor) in continuous forming, and the case where no coating discontinuity occurred was determined as fair (Good) in continuous forming.

(Abrasion Test)

By using the pellets and a heat press molding machine, a sheet-shape test piece of approximately 0.2 mm in thickness was prepared, and a test piece having 10 cm×10 cm was cut out therefrom. The prepared test piece was fixed to a test bench of a Taber abrasion tester (No. 101 Taber type abrasion tester with an option, manufactured by YASUDA SEIKI SEISAKUSHO, LTD.), and the abrasion test was carried out using the Taber abrasion tester under the condition of a test piece surface temperature of 150° C., a load of 500 g, an abrasion wheel CS-10 (rotationally polished in 20 rotations with an abrasive paper #240), and a rotation rate of 60 rpm. The weight of the test piece after 1,000 rotations was measured, and the same test piece was further subjected to the test of 5,000 rotations, and then the weight of the test piece was measured. The abrasion loss was determined by the following formula:

Abrasion loss (mg)=M1−M2
M1: the weight of the test piece after 1,000 rotations (mg)
M2: the weight of the test piece after 5,000 rotations (mg)

(Nitrogen Permeability Coefficient)

By using the pellets and a heat press molding machine, a sheet-shape test piece of approximately 0.1 mm in thickness was prepared. Using the obtained test piece, nitrogen permeability was measured with a differential pressure type gas permeation meter (L100-5000 gas permeability meter, manufactured by Systech Illinois) according to the method described in JIS K7126-1:2006. The nitrogen permeability value at a permeation area of 50.24 cm² at a test temperature of 70° C. at a test humidity of 0% RH was obtained. The obtained nitrogen permeability and the test piece thickness were used to calculate the nitrogen permeability coefficient from the following equation.

Nitrogen permeability coefficient(cm³·mm/(m²·24h·atm))=GTR×d
GTR: nitrogen permeability (cm³/(m²·24 h·atm))
d: test piece thickness (mm)

(Methyl Ethyl Ketone (MEK) Permeability)

By using the pellets and a heat press molding machine, a sheet-shape test piece of approximately 0.1 mm in thickness was prepared. 10 g of MEK was put in a test cup (permeation area: 12.56 cm²), and the test cup was covered with the sheet-shape test piece; and a PTFE gasket was pinched and fastened to hermetically close the test cup. The sheet-shape test piece was brought into contact with MEK, and held at a temperature of 60° C. for 60 days, thereafter the test cup was taken out and allowed to stand at room temperature for 1 hours, and then the amount of the mass lost was measured. MEK permeability (mg·cm/m²·day) was determined by the following formula:

MEK permeability(mg·cm/m²·day)=[the amount of the mass lost (mg)×the thickness of the sheet-shape test piece (cm)]/[the permeation area(m²)·number of days (day)]

(Rate of Deflection at 95° C. Under Load)

By using the pellets and a heat press molding machine, a sheet-shape test piece of approximately 3 mm in thickness, and a test piece having 80×10 mm was cut out therefrom and heated in an electric furnace at 100° C. for 20 hours. Except that the obtained test piece was used, a test was carried out according to the method described in JIS K-K 7191-1 with a heat distortion tester (manufactured by YASUDA SEIKI SEISAKUSHO, LTD.) under conditions of a test temperature of 30 to 150° C., a temperature-increasing rate of 120° C./hour, a bending stress of 1.8 MPa, and a flatwise method. The rate of deflection under load was determined by the following formula. A sheet, the rate of deflection at 95° C. under load of which is small, has excellent high-temperature rigidity.

Rate of deflection under load (%)=a2/a1×100
a1: thickness of the test piece before the test (mm)
a2: amount of deflection at 95° C. (mm)

(Tensile Creep Test)

Tensile creep strain was measured using TMA-7100 manufactured by Hitachi High-Tech Science Corporation. By using the pellets and a heat press molding machine, a sheet of approximately 0.1 mm in thickness was prepared, and a sample of 2 mm in width and 22 mm in length was prepared from the sheet. The sample was attached to the measurement jigs, with the distance between the jigs being 10 mm. A load was applied to the sample such that the cross-sectional load was 3.32 N/mm², the sample was allowed to stand at 200° C., the displacement (mm) of the length of the sample from 90 minutes after the beginning of the test to 1,320 minutes after the beginning of the test was measured, and the ratio of the displacement (mm) of the length to the initial sample length (10 mm) (tensile creep strain (%)) was calculated. A sheet, the tensile creep strain (%) of which measured under conditions of a temperature of 200° C. and for 1,320 minutes is small, is hardly elongated even when a tensile load is applied for a long term in a high-temperature environment, and has excellent long-term tensile creep property.

(60,000-Time Tensile Strength Retention Rate)

The 60,000-time tensile strength retention rate was measured using a fatigue tester MMT-250NV-10 manufactured by Shimadzu Corporation. By using the pellets and a heat press molding machine, a sheet-shape test piece of approximately 2.4 mm in thickness was prepared, and an ASTM D1708 micro-dumbbell was used to prepare a dumbbell-shaped sample (thickness 2.4 mm, width 5.0 mm, length of measured portion 22 mm). The sample was attached to a measuring jig, and with the sample being attached, the measuring jig was put in a thermostatic chamber of 150° C. The sample was cyclically pulled in the uniaxial direction at a stroke of 0.2 mm and a frequency of 100 Hz, and the tensile strength for each pull (the tensile strength when the stroke was +0.2 mm) was measured. The 60,000-time tensile strength retention rate was calculated from the measured values according to the following formula.

60,000−tensile strength retention rate (%)=tensile strength(60,000times)(mN)/tensile strength(5,000times)(mN)×100

The 60,000-time tensile strength retention rate is the ratio of the tensile strength when repetitive load was applied 60,000 times to the tensile strength when repetitive load was applied 5,000 times. A sheet having a high 60,000-time tensile strength retention rate maintains the initial tensile strength even after load is applied 60,000 times, and has excellent deterioration resistance against repetitive load.

(Hydrogen Peroxide Solution Immersion Test)

25 g of pellets was immersed in 50 g of a 3% by weight aqueous hydrogen peroxide solution, heated at 90° C. for 20 hours in an electric furnace, further heated at 121° C. for 1 hour in a sterilizer, and then cooled to room temperature. The pellets were taken out from the aqueous solution, TISAB solution (10) (manufactured by Kanto Chemical Co., Inc.) was added to the remaining aqueous solution, and the fluorine ion concentration in the obtained aqueous solution was measured with a fluorine ion meter. From the obtained measured value, the fluorine ion concentration (the amount of fluorine ions dissolving out) per pellet weight was calculated according to the following formula:

Amount of fluorine ions dissolving out (mass ppm)=measured value(mass ppm)×the amount of the aqueous solution (g)/pellet weight (g)

(Ozone Exposure Test)

The copolymer was compression-molded at 350° C. under a pressure of MPa to prepare a sheet of 1 mm in thickness, and a sheet of 10×20 mm was cut out therefrom, which was regarded as a sample for an ozone exposure test. Ozone gas (ozone/oxygen=10/90% by volume) produced by an ozone generator (trade name: SGX-A11MN (modified), manufactured by Sumitomo Precision Products Co., Ltd.) was connected to a PFA container containing ion-exchanged water, bubbled in ion-exchanged water to add water vapor to ozone gas, and then ion-exchanged water was passed through the sample-containing PFA cell at 0.7 liters/min at room temperature to expose the sample to wet ozone gas. The sample was taken out 30 days after the beginning of exposure, the surface was lightly rinsed with ion-exchanged water, a portion at a depth of to 200 μm from the sample surface was observed with a transmission optical microscope of 100 magnification, an image was taken with a standard scale, the number of cracks of 10 μm in length or more per mm² of the sample surface was measured, and evaluations were made according to the following criteria.
Good: 10 cracks or less
Poor: more than 10 cracks

(Dielectric Loss Tangent)

By melt forming the pellets, a cylindrical test piece of 2 mm in diameter was prepared. The prepared test piece was set in a cavity resonator for 6 GHz, manufactured by Kanto Electronic Application and Development Inc., and the dielectric loss tangent was measured by a network analyzer, manufactured by Agilent Technologies Inc. By analyzing the measurement result by analysis software “CPMA”, manufactured by Kanto Electronic Application and Development Inc., on PC connected to the network analyzer, the dielectric loss tangent (tan δ) at 20° C. at 6 GHz was determined.

TABLE 4

| | | | 150° C. | | | | | | |
|---|---|---|---|---|---|---|---|---|---|
| | | Water | Storage | Amount | | | | | 150° C. |
| | Chemical | vapor | elastic | of | 150° C. | | Electric wire coating test | | Abrasion |
| | immersion | permeability | modulus | recovery | Resilience | Injection | Coating | Spark | loss |
| | crack test | (g · cm/m²) | (MPa) | (mm) | (MPa) | moldability | discontinuity | Evaluation | (mg) |
| Example 1 | Good | 7.9 | 126 | 0.016 | 0.67 | 2 | Good | Good | 33.7 |
| Example 2 | Good | 7.8 | 127 | 0.017 | 0.72 | 2 | Good | Good | 34.3 |
| Example 3 | Good | 7.9 | 129 | 0.018 | 0.77 | 2 | Good | Good | 34.0 |
| Example 4 | Good | 7.9 | 130 | 0.020 | 0.87 | 2 | Good | Good | 33.7 |
| Example 5 | Good | 7.9 | 133 | 0.022 | 0.98 | 2 | Good | Good | 33.4 |
| Example 6 | Good | 7.8 | 134 | 0.022 | 0.98 | 2 | Good | Good | 33.9 |
| Comparative | Good | 8.5 | 121 | 0.021 | 0.85 | 1 | — | — | 31.7 |
| Example 1 | | | | | | | | | |
| Comparative | Poor | 7.2 | 135 | 0.008 | 0.36 | 2 | — | — | 38.5 |
| Example 2 | | | | | | | | | |
| Comparative | Poor | 7.0 | 143 | 0.025 | 1.19 | 2 | — | — | 35.5 |
| Example 3 | | | | | | | | | |
| Comparative | Good | 9.2 | 105 | 0.013 | 0.46 | 2 | — | — | 31.7 |
| Example 4 | | | | | | | | | |
| Comparative | Good | 9.1 | 110 | 0.016 | 0.59 | 2 | — | — | 31.7 |
| Example 5 | | | | | | | | | |

| | | | | | | Hydrogen | | |
|---|---|---|---|---|---|---|---|---|
| | | | | | | peroxide | | |
| | Nitrogen | | | | | solution | | |
| | permeability | | | | 60.000- | immersion | | |
| | coefficient | MEK | Rate of | | Time | test | | |
| | cm³ · | permeability | deflection | 200° C. | tensile | Amount of | | |
| | mm/ | (mg · | at 95° C. | Tensile | strength | fluorine ions | Ozone | |
| | (m² · | cm/ | under | creep | retention | dissolving | exposure | |
| | 24 h · | m² · | load | strain | rate | out | test | Dielectric |
| | atm) | day) | (%) | (%) | (%) | (ppm by mass) | 30 days | tangent |
| Example 1 | 236 | 57.8 | 41 | 2.12 | 93.2 | 1.7 | Good | 0.00034 |
| Example 2 | 232 | 57.3 | 40 | 2.05 | 92.6 | 1.7 | Good | 0.00034 |
| Example 3 | 232 | 57.4 | 39 | 1.98 | 92.0 | 1.6 | Good | 0.00034 |
| Example 4 | 229 | 57.5 | 39 | 1.92 | 91.5 | 1.6 | Good | 0.00034 |
| Example 5 | 229 | 57.6 | 39 | 1.86 | 91.1 | 1.5 | Good | 0.00034 |
| Example 6 | 225 | 57.1 | 37 | 1.80 | 90.7 | 1.5 | Good | 0.00033 |
| Comparative | 259 | 59.5 | 43 | 2.12 | 93.2 | 1.3 | Good | 0.00034 |
| Example 1 | | | | | | | | |
| Comparative | 216 | 55.0 | 37 | 2.05 | 92.6 | 1.7 | Poor | 0.00033 |
| Example 2 | | | | | | | | |
| Comparative | 207 | 55.3 | 33 | 1.50 | 86.6 | 1.3 | Poor | 0.00033 |
| Example 3 | | | | | | | | |
| Comparative | 259 | 60.1 | 47 | 2.58 | 97.8 | 2.0 | Good | 0.00036 |
| Example 4 | | | | | | | | |
| Comparative | 258 | 60.5 | 46 | 2.41 | 96.6 | 22.5 | Poor | 0.00045 |
| Example 5 | | | | | | | | |

1. A copolymer, comprising tetrafluoroethylene unit and perfluoro(propyl vinyl ether) unit,
wherein the copolymer has a content of perfluoro(propyl vinyl ether) unit of 3.3 to 4.2% by mass with respect to the whole of the monomer units,
a melt flow rate at 372° C. of 27.0 to 35.0 g/10 min, and
the total number of —CF═CF₂, —CF₂H, —COF, —COOH, —COOCH₃, —CONH₂ and —CH₂OH of 20 or less per 10′ main-chain carbon atoms.

2. The copolymer according to claim 1, wherein the copolymer has a melt flow rate at 372° C. of 27.0 to 33.3 g/10 min.

3. An injection molded article, comprising the copolymer according to claim 1.

4. A coated electric wire, comprising a coating layer comprising the copolymer according to claim 1.

5. A formed article, comprising the copolymer according to claim 1, wherein the formed article is a wafer carrier, a gasket, or an electric wire coating.
